(19) United States
(12) Patent Application Publication
(10) Pub. No.: US 2015/0304336 A1
(43) Pub. Date: Oct. 22, 2015

(54) MULTI-SCREEN INTERACTION METHOD OF MULTIMEDIA RESOURCE AND TERMINAL DEVICE

(71) Applicants: Hisense Co., Ltd., Qingdao (CN); HISENSE USA CORPORATION, Suwanee, GA (US)

(72) Inventor: Chunyu YU, Qingdao (CN)

(21) Appl. No.: 14/340,823

(22) Filed: Jul. 25, 2014

(30) Foreign Application Priority Data
Apr. 18, 2014 (CN) 201410158808.2

(51) Int. Cl. H04L 29/06; H04L 29/08

(52) U.S. Cl. CPC H04L 63/105; H04L 67/02

(57) ABSTRACT

A multi-screen interaction method of a multimedia resource and a terminal device are disclosed. With the method, security grades of multimedia resources to be shared and a security grade authorization threshold are set for a terminal device, and a display device plays a multimedia resource stored on the terminal device according to the security grade authorization threshold.

### CROSS-REFERENCE TO RELATED APPLICATION

This application claims priority to Chinese Patent Application No. 201410158808.2, filed with the Chinese Patent Office on Apr. 18, 2014, and entitled “Multi-screen interaction method of multimedia resource and Terminal device”, the disclosure of which is hereby incorporated by reference in its entirety.

### FIELD

The present disclosure relates to the field of communications and particularly to a multi-screen interaction method of a multimedia resource and a terminal device.

### BACKGROUND

At present a user can play a multimedia resource using various terminal devices, for example, the user can play a video resource, a picture, etc., using a smartphone, a smart tablet PC, a computer, a TV set, etc. Sharing of the same multimedia resource between different terminal devices, i.e., the technology of multi-screen interaction, is an ongoing development trend of terminal devices, for example, a movie stored on a handset is played on a TV terminal, or a picture stored on a tablet PC is displayed on a TV terminal, or the contents in a computer are played on a TV terminal.

The technology of multi-screen interaction enables compatibility between different operating systems (such as an Android system, an iOS system, a Symbian system, a Windows Phone system, a Sailfish OS system, an Ubuntu Touch system or any other mobile operating systems, and a WIN7 system, a WINDOWS XP system, a VISTA system or any other computer operating systems, etc.) and between different terminal devices (such as a smartphone, a TV set, a smart tablet PC, a computer, etc.) as well as interoperation between the different operating systems or between the different terminal devices. This technology enables transmission of a multimedia resource across terminal devices over a wireless network connection or a wired network connection.

### SUMMARY

An embodiment of the disclosure provides a multi-screen interaction method of a multimedia resource including:

receiving, by a terminal device, a security grade authorization request transmitted from a display device and determining a security grade authorization threshold according to the display device; and

determining, by the terminal device, multimedia resources to be played and transmitting play information corresponding to the multimedia resources to be played to the display device according to the security grade authorization threshold.

An embodiment of the disclosure further provides multi-screen interaction method of a multimedia resource including:

receiving, by a terminal device, a security grade authorization request transmitted from a display device, determining a security grade authorization threshold according to the display device, and transmitting the security grade authorization threshold to the display device; and

determining multimedia resources to be played among multimedia resources to be shared according to the security grade authorization threshold.

An embodiment of the disclosure provides a terminal device including:

a memory; and

one or more processors,

wherein the memory has computer readable program codes stored therein, and one or more processors are configured to execute the computer readable program codes to perform:

receiving, by the terminal device, a security grade authorization request transmitted from a display device, determining a security grade authorization threshold according to the display device; and

determining, by the terminal device, multimedia resources to be played and transmitting play information corresponding to the multimedia resources to be played to the display device according to the security grade authorization threshold.

An embodiment of the disclosure provides a terminal device including:

a memory; and

one or more processors,

wherein the memory has computer readable program codes stored therein, and one or more processors are configured to execute the computer program codes to perform:

receiving, by the terminal device, a security grade authorization request transmitted from a display device, determining a security grade authorization threshold according to the display device, and transmitting the security grade authorization threshold to the display device; and

determining, by the terminal device, multimedia resources to be played among multimedia resources to be shared according to the security grade authorization threshold.

### BRIEF DESCRIPTION OF THE DRAWINGS

FIG. 1 is a flow chart of a multi-screen interaction method of a multimedia resource according to an embodiment of the disclosure;

FIG. 2 is a flow chart of another multi-screen interaction method of a multimedia resource according to an embodiment of the disclosure;

FIG. 3a is a schematic diagram of a multi-screen interaction method of a multimedia resource according to an embodiment of the disclosure;

FIG. 3b is a schematic diagram of a multi-screen interaction method of a multimedia resource according to an embodiment of the disclosure;

FIG. 4 is a flow chart of a multi-screen interaction method of a multimedia resource according to an embodiment of the disclosure;

FIG. 5 is a flow chart of a multi-screen interaction method of a multimedia resource according to another embodiment of the disclosure;

FIG. 6 is a schematic diagram of a multi-screen interaction method of a multimedia resource according to another embodiment of the disclosure;

FIG. 7 is a schematic structural diagram of a terminal device according to an embodiment of the disclosure; and

FIG. 8 is a schematic structural diagram of a display device according to an embodiment of the disclosure.

### DETAILED DESCRIPTION OF THE EMBODIMENTS

Embodiments of the disclosure provide a multi-screen interaction method of a multimedia resource, which is applicable to various devices which can play a multimedia resource, and the embodiments of the disclosure will be described below with reference to the drawings.

A multi-screen interaction refers to the interaction or mutual influence between two or more than two display screens, to process or display the same or related content thereon; wherein the two or more than two display screens belong to the same equipment or belong to different equipments.

An embodiment of the disclosure provides a multi-screen interaction method of a multimedia resource, which can be applicable to at least two scenarios, where in one of the scenarios, a multimedia resource in a terminal device is pushed to a display device, and in another scenario, the display device browses and/or plays a multimedia resource of the terminal device. In some embodiments of the disclosure, the terminal device can be, for example, a handset, a computer or another device, and the display device can be, for example, a TV set or another device with a play function.

Referring to FIG. 1, an embodiment of the disclosure provides a multi-screen interaction method of a multimedia resource, and a processing flow thereof includes:

Step 101: A terminal device receives a security grade authorization request transmitted from a display device and determines a security grade authorization threshold according to the display device.

In an embodiment, the terminal device can transmit a discovery request with a multicast address after the terminal device accesses the same network as the display device or establishes a connection with the display device through a connection line, and the display device can transmit a response message and the security grade authorization request to the terminal device upon reception of the discovery request.

Where the terminal device and the display device can be various devices that can play a multimedia resource.

The terminal device can transmit the discovery request with the multicast address as follows: the terminal device transmits the discovery request with the multicast address to the display device sharing the same multicast address as the terminal device.

The display device transmits the response message carrying the device identifier of the display device and a corresponding play type of the display device to the terminal device, and transmits the security grade authorization request to the terminal device, upon reception of the discovery request, where the corresponding play type of the display device is a play service capability of the display device.

The terminal device determines the security grade authorization threshold according to the display device upon reception of the security grade authorization request.

The terminal device can read the security grade authorization threshold corresponding to the display device, wherein the security grade authorization threshold can be preset or can be set by the terminal device after the terminal device received the security grade authorization request transmitted from the display device. For example, the terminal device can display a setting message of the security grade authorization threshold upon reception of the security grade authorization request transmitted from the display device and determine the security grade authorization threshold in response to a received user instruction. Optionally if the display device has no corresponding security grade authorization threshold, then the terminal device can determine the security grade authorization threshold corresponding to the display device in response to the received user instruction. Moreover, the terminal device can further store the determined security grade authorization threshold. Thus, the security grade authorization threshold corresponding to the display device can be set by a user when the terminal device establishes a connection with the display device (for example, which is established for the first time); or the preset security grade authorization threshold stored in the terminal device can be read directly when the terminal device establishes a connection with the display device (for example, which is established for the non-first time).

Moreover, the terminal device can further modify the security grade authorization threshold after reading the preset security grade authorization threshold corresponding to the display device.

Step 102: The terminal device determines multimedia resources to be played and transmits play information corresponding to the multimedia resources to be played to the display device according to the security grade authorization threshold.

Wherein a security grade of a multimedia resource can be set per category, for example, the same security grade can be set for a specific category of multimedia resources; or security grades can be set separately for multimedia resources, for example, one security grade can be set for each multimedia resource, and security grades of different multimedia resources can be the same or different. Moreover, for example, security grades of a multimedia resource can be set when the multimedia resource is stored at the terminal device or when the multimedia resource is opened by the terminal device or when the terminal device transmits play information corresponding to the multimedia resource to the display device.

In an embodiment, the terminal device firstly selects the multimedia resources to be played according to the received response message as follows:

The terminal device selects, among multimedia resources to be shared in the terminal device, the multimedia resources to be played corresponding to the device identifier of the display device and the corresponding play type of the display device in the response message, and then determines one or more multimedia resources to be played in response to a user instruction.

In an embodiment, the terminal device can preset security grades of the multimedia resources to be shared according to file locations, file types and other aspects of the multimedia resources to be shared. The terminal device transmits the play information corresponding to the multimedia resources to be played to the display device according to the security grade authorization threshold as follows:

Determining security grades of the multimedia resources to be played;

Judging whether the security grades of the multimedia resources to be played are smaller than or equal to the security grade authorization threshold; and

If so, then transmitting the play information corresponding to the multimedia resources to be played directly to the display device;

Otherwise, displaying an alarm message, and transmitting the play information corresponding to the multimedia resources to be played to the display device after the alarm message is cleared.

In an embodiment, the play information corresponding to the multimedia resources to be played is a Uniform Resource Identifier (URI) of the multimedia resources to be played.

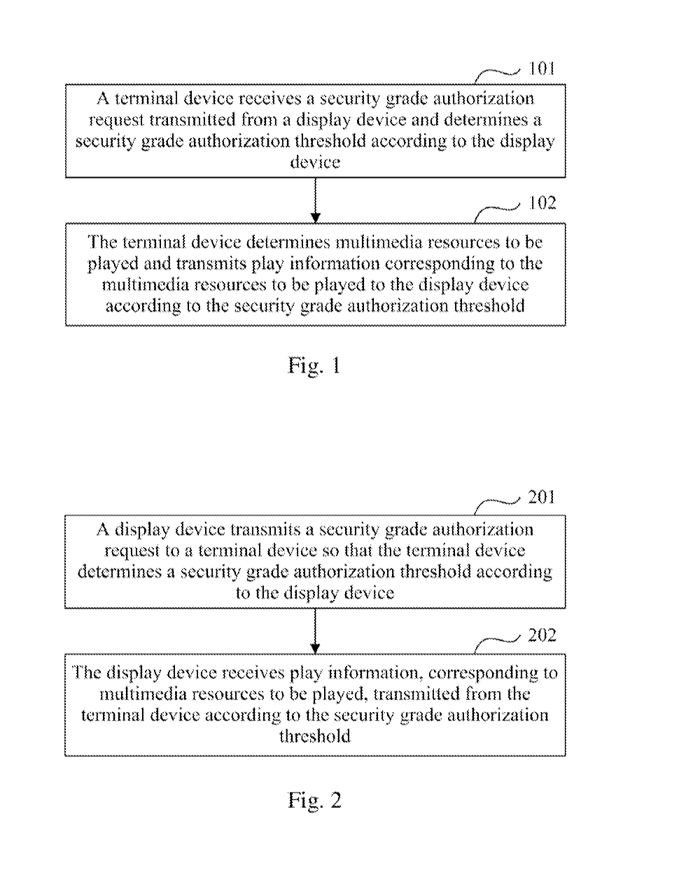

Referring to FIG. 2, another embodiment of the disclosure provides a multi-screen interaction method of a multimedia resource, and a processing flow thereof is as follows:

Step 201: A display device transmits a security grade authorization request to a terminal device.

The terminal device can determine a security grade authorization threshold according to the display device upon reception of the security grade authorization request transmitted from the display device, wherein for a process in which the terminal device determines the security grade authorization threshold according to the display device, reference can be made to the process in the foregoing embodiment.

Step 202: The display device receives play information, corresponding to multimedia resources to be played, transmitted from the terminal device according to the security grade authorization threshold, wherein the security grade authorization threshold is determined according to the display device by the terminal device.

In an embodiment, the step 202 includes:

The display device receives play information, corresponding to the multimedia resources to be played satisfying a play condition specified by the security grade authorization threshold, transmitted from the terminal device; or

The display device receives play information, corresponding to the multimedia resources to be played failing to satisfy the play condition specified by the security grade authorization threshold, transmitted from the terminal device after an alarm message is cleared.

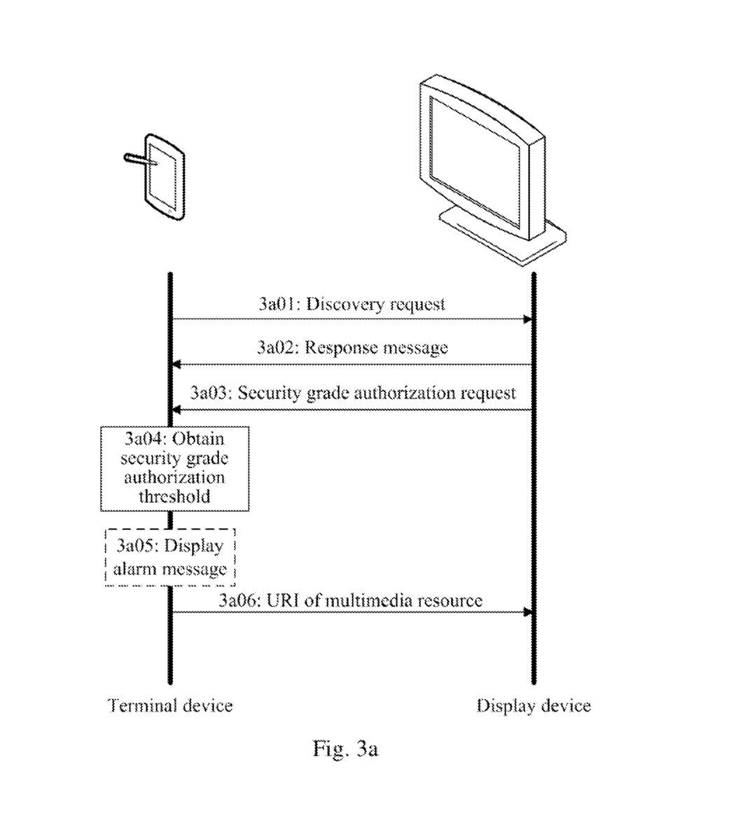

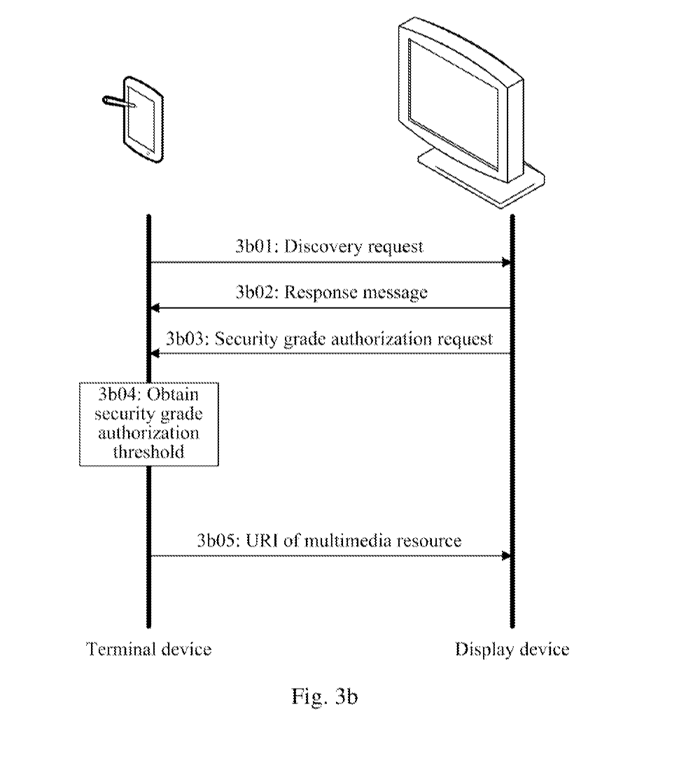

Referring to FIG. 3a, there is illustrated a schematic diagram of another multi-screen interaction method of a multimedia resource, and optionally a terminal device is a mobile terminal (e.g., a smartphone), and a display device is a smart TV set, and a flow of this embodiment includes:

Step 3a01: The mobile terminal transmits a discovery request with a multicast address to the smart TV set after the mobile terminal accesses the same network as the smart TV set.

Step 3a02: The smart TV set transmits a response message to the mobile terminal upon reception of the discovery request.

Step 3a03: The smart TV set transmits a security grade authorization request to the mobile terminal.

Step 3a04: The mobile terminal reads a preset security grade authorization threshold upon reception of the security grade authorization request.

Step 3a05: The mobile terminal judges whether to display an alarm message at the mobile terminal according to the security grade authorization threshold and selected multimedia resources to be played.

Step 3a06: The mobile terminal transmits a URI corresponding to the multimedia resources to be played to the smart TV set when no alarm message is displayed or the alarm message is displayed and then the alarm message is cleared.

Referring to FIG. 3b, there is illustrated a schematic diagram of another multi-screen interaction method of a multimedia resource, and optionally a terminal device is a mobile terminal (e.g., a smartphone), and a display device is a smart TV set, and a flow of this embodiment includes:

Step 3b01: The mobile terminal transmits a discovery request with a multicast address to the smart TV set after the mobile terminal accesses the same network as the smart TV set.

Step 3b02: The smart TV set transmits a response message to the mobile terminal upon reception of the discovery request.

Step 3b03: The smart TV set transmits a security grade authorization request to the mobile terminal.

Step 3b04: The mobile terminal reads a preset security grade authorization threshold upon reception of the security grade authorization request.

Step 3b05: The mobile terminal transmits URIs corresponding to multimedia resources to be played to the smart TV set.

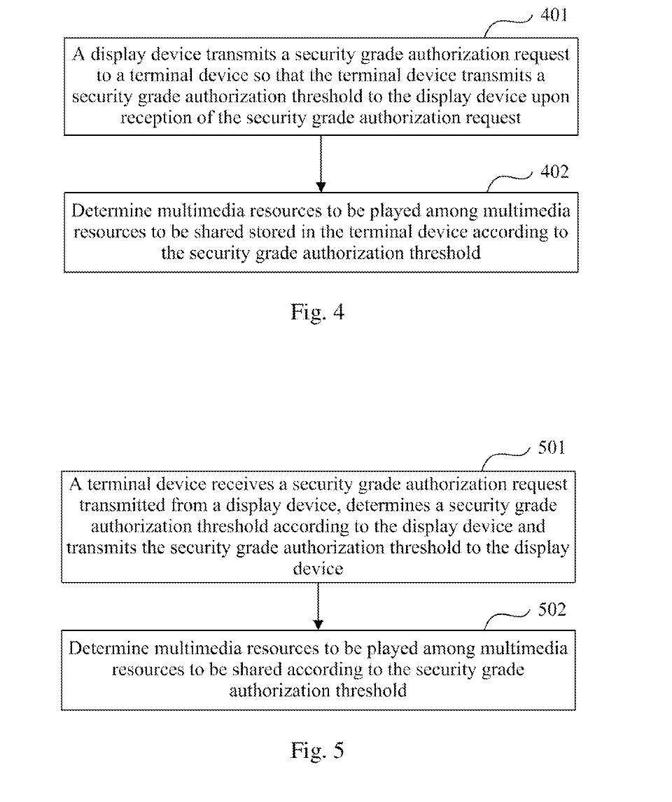

Referring to FIG. 4, still another embodiment of the disclosure provides a multi-screen interaction method of a multimedia resource, and a processing flow thereof is as follows:

Step 401: A display device transmits a security grade authorization request to a terminal device so that the terminal device transmits a security grade authorization threshold to the display device upon reception of the security grade authorization request.

In an embodiment, the display device transmits a discovery request with a multicast address after accessing the same network as the terminal device, and the terminal device transmits a response message to the display device upon reception of the discovery request.

The display device transmits the discovery request with the multicast address, which is similar to the step 101 in which the terminal device transmits the discovery request, and a repeated description thereof will be omitted here.

The response message transmitted from the terminal device carries the device identifier of the terminal device and a corresponding play type (i.e., a play service capability) of the terminal device.

The display device transmits the security grade authorization request to the terminal device upon reception of the response message, and the terminal device can transmit the determined security grade authorization threshold to the display device upon reception of the security grade authorization request.

Wherein the terminal device can preset security grades of multimedia resources to be shared according to file locations, file types and other aspects of the multimedia resources to be shared and can further preset the security grade authorization threshold corresponding to the display device.

Step 402: The display device determines multimedia resources to be played among multimedia resources to be shared in the terminal device according to the security grade authorization threshold.

In an embodiment, the step 402 includes:

The display device transmits a browse request message carrying the security grade authorization threshold to the terminal device, and the terminal device selects, among the multimedia resources to be shared therein, multimedia resources, with security grades satisfying a play condition specified by the security grade authorization threshold corresponding to the display device, as the multimedia resources to be played according to the security grades of the multimedia resources to be shared. Optionally a security grade of a multimedia resource being smaller than the security grade authorization threshold corresponding to the display device can be taken as the security grade satisfying the play condition specified by the security grade authorization threshold corresponding to the display device.

In an embodiment, the display device can add an entry of the terminal device to a local multimedia center upon reception of the response message, the display device stores the security grade authorization threshold after the terminal device transmits the security grade authorization threshold to the display device; and a user transmits a browse message to any terminal device at the entry of the terminal device in the multimedia center of the display device by carrying the security grade authorization threshold in the browse message.

Referring to FIG. 5, still another embodiment of the disclosure provides a multi-screen interaction method of a multimedia resource, and a processing flow thereof is as follows:

Step 501: A terminal device receives a security grade authorization request transmitted from a display device, determines a security grade authorization threshold according to the display device and transmits the security grade authorization threshold to the display device.

In an embodiment, the terminal device determines the security grade authorization threshold according to the display device includes:

The terminal device reads the security grade authorization threshold corresponding to the display device, wherein the security grade authorization threshold can be preset or can be set by the terminal device upon reception of a security grade authorization request transmitted from the display device. For example, the terminal device can display a setting message of the security grade authorization threshold upon reception of the security grade authorization request transmitted from the display device and determine the security grade authorization threshold in response to a received user instruction. Optionally after the terminal devices receives the security grade authorization request transmitted from the display device, if the display device has no corresponding security grade authorization threshold, then the terminal device can determine the security grade authorization threshold corresponding to the display device in response to the received user instruction. Then the terminal device can further store the determined security grade authorization threshold. Thus the security grade authorization threshold corresponding to the display device can be set by a user when the terminal device establishes a connection with the display device for the first time, and the preset security grade authorization threshold stored in the terminal device can be acquired directly when the terminal device establishes a connection with the display device for the non-first time.

Moreover the terminal device can further modify the security grade authorization threshold after reading the preset security grade authorization threshold corresponding to the display device.

Step 502: The terminal device determines multimedia resources to be played among multimedia resources to be shared according to the security grade authorization threshold.

In an embodiment, the step 502 includes:

The terminal device receives a browse request message transmitted from the display device based upon the security grade authorization threshold; and

The terminal device selects, among the multimedia resources to be shared, multimedia resources, with security grades satisfying a play condition specified by the security grade authorization threshold, as the multimedia resources to be played according to security grades of the multimedia resources to be shared.

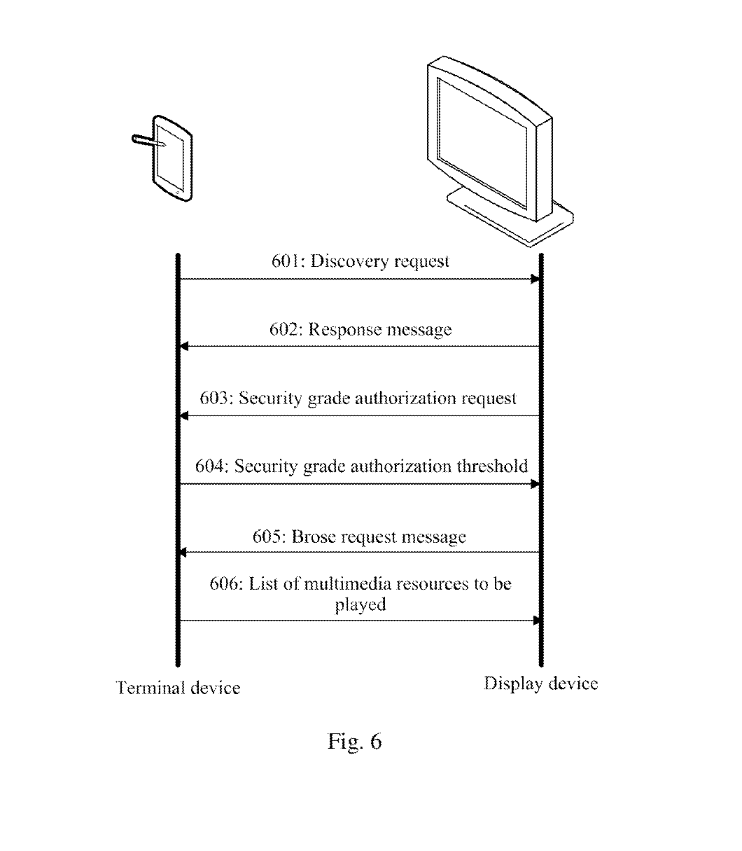

Referring to FIG. 6, a schematic diagram of another multi-screen interaction method of a multimedia resource is illustrated, and optionally a terminal device is a mobile terminal (e.g., a smartphone), and a display device is a smart TV set, and a flow of this embodiment includes:

Step 601: The smart TV set transmits a discovery request with a multicast address to the mobile terminal after the smart TV set accesses the same network as the mobile terminal.

Step 602: The mobile terminal transmits a response message to the smart TV set upon reception of the discovery request.

Step 603: The smart TV set transmits a security grade authorization request to the mobile terminal.

Step 604: The mobile terminal reads and transmits a preset security grade authorization threshold to the smart TV set upon reception of the security grade authorization request.

Step 605: The smart TV set transmits a browse request message to the mobile terminal through a local multimedia center, wherein the browse request message carries the security grade authorization threshold.

S606: The mobile terminal selects multimedia resources to be played satisfying the security grade authorization threshold in response to the received browse request message and creates and transmits a list of multimedia resources to the smart TV set so that a user can select one of the multimedia resources to be played at the smart TV end.

For example, the user sets security grades of multimedia resources per file folder or file through the terminal device (e.g., the smartphone), for example, the user divides a plurality of folders or a plurality of files into 6 security grades, and sets the security grade authorization threshold corresponding to the smart TV set to 3.

In an example, the smartphone transmits the discovery request with the multicast address after the smartphone accesses the same network as the smart TV set; the smart TV set in the same network transmits the response message and the security grade authorization request to the smartphone upon reception of the discovery request; the smartphone reads the preset security grade authorization threshold of 3 corresponding to the smart TV set upon reception of the security grade authorization request; and the smartphone selects the multimedia resources to be played according to a play capability of the smart TV set in the response message; and after the user selects one of the multimedia resources, the user determines the security grade of the multimedia resource, and if it is larger than 3, then the smartphone displays an alarm message to alert the user; otherwise, the multimedia resource is pushed directly to the smart TV set.

In another example, the smart TV set transmits the discovery request with the multicast address after the smart TV set accesses the same network as the smartphone; the smartphone in the same network transmits the response message to the smart TV set upon reception of the discovery request; the smart TV set receives the response message and transmits the security grade authorization requests to the smartphone, and the smartphone transmits the preset security grade authorization threshold corresponding to the smart TV set to the smart TV set; the smart TV set transmits the browse request message to the smartphone through the local multimedia center, wherein the browse request message contains the security grade authorization threshold of 3 corresponding to the smart TV set; and the smartphone creates and transmits to the smart TV set a list of resources including locally stored multimedia resources with security grades no larger than the security grade authorization threshold of 3 upon reception of the browse request message.

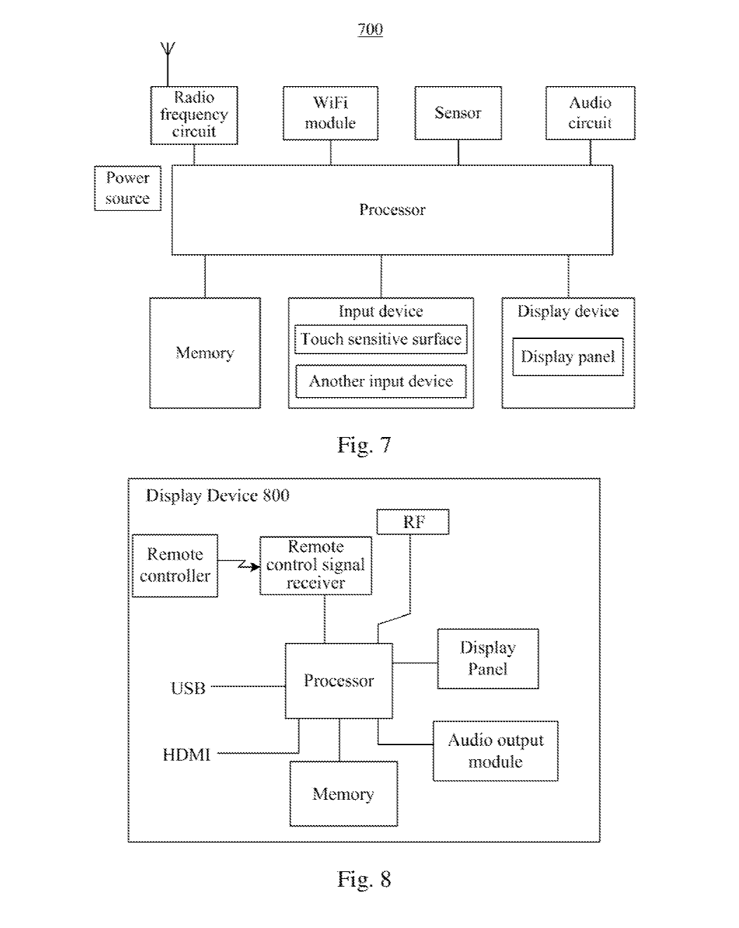

An embodiment of the disclosure further provides a terminal device, and FIG. 7 illustrates a schematic structural diagram of a terminal device, wherein the terminal device 700 can be various handheld devices (e.g., a smartphone, a tablet PC, a PDA, etc.) which can include a processor including one or more processing cores, a radio frequency circuit, a memory including one or more computer readable storage mediums, an input device, a display component, a sensor, an audio circuit, a WiFi module, a power source and other components. Those skilled in the art can appreciate that the terminal device will not be limited to the structure of the terminal device 700 illustrated in FIG. 7 but can include more or fewer components than those illustrated in the figure or have some of the components combined or have different components arranged, wherein:

The radio frequency circuit can be configured to receive and transmit a signal in process of receiving and transmitting information or communication, particularly by transferring downlink information transmitted from a base station to the one or more processors for processing upon reception of the downlink information; and also transmitting uplink data to the base station. Typically the radio frequency circuit includes but will not be limited to an antenna, at least one amplifier, a tuner, one or more oscillators, a Subscriber Identifier Module (SIM) card, a transceiver, a coupler, a Low Noise Amplifier (LNA), a duplexer, etc. Moreover the radio frequency circuit can further communicate with a network and another device through wireless communication. The wireless communication can comply with any of communication standards or protocols including but not limited to the GSM (Global System of Mobile communication), the GPRS (General Packet Radio Service), the CDMA (Code Division Multiple Access), the WCDMA (Wideband Code Division Multiple Access), the LTE (Long Term Evolution), an e-mail, the SMS (Short Messaging Service), etc.

The memory can be configured to store software programs and modules, and the processor is configured to run the software programs and modules stored in the memory to thereby perform various function applications and data processing. The memory can generally include a program storage area and a data storage area, wherein an operating system, applications required for at least one function (e.g., a function for playing audio, a function for playing, etc.), etc., can be stored in the program storage area; and data created for use of the terminal device 700 (e.g., audio data, an address book etc.), etc., can be stored in the data storage area. Moreover the memory can include a high-speed random access memory and can further include a nonvolatile memory, e.g., at least one magnetic-disk memory device, a flash memory device or another volatile solid-state memory device. Correspondingly the memory can further include a memory controller configured to provide an access of the processor and the input device to the memory.

The input device can be configured to receive input digital or character information and to generate a keyboard, mouse, joystick, optical or track ball signal input related to user setting and function control. Particularly the input device can include a touch sensitive surface and another input device. The touch sensitive surface, also referred to as a touch display screen or a touch control panel, can be configured to collect a touch operation by a user thereon or in proximity thereto (e.g., an operation by the user on or in proximity to the touch sensitive surface using his or her finger, a stylus or any other appropriate object or attachment) and to drive a corresponding connected device by preset program. Optionally the touch sensitive surface can include two components which are a touch detection device and a touch controller, wherein the touch detection device detects the position of touching of the user and detects a signal as a result of the touch operation and transfers the signal to the touch controller; and the touch controller receives the touch signal from the touch detection device and converts it into coordinates of a touch point and further transfers them to the processor and can receive and execute a command sent from the processor. Moreover the touch sensitive surface can be implemented in various types of resistive, capacitive, infrared, surface sound wave and other types. The input device can further include another input device in addition to the touch sensitive surface. Particularly the other input device can include but will not be limited to one or more of a physical keyboard, functional keys (e.g., volume control press keys, a power-on or-off press key, etc.), a track ball, a mouse, a joystick, etc.

The display component can be configured to display information input by the user or information provided to the user and various graphic user interfaces of the terminal device 700, where these graphic user interfaces can be composed of graphics, texts, icons, videos and any combination thereof. The display component can include a display panel which can be optionally configured in the form of a Liquid Crystal Display (LCD), an Organic Light-Emitting Diode (OLED) display, etc. Furthermore the touch sensitive surface can cover the display panel, and the touch sensitive surface, upon detection of the touch operation thereon or in proximity thereto, transfers it to the processor to determine the type of the touch event, and thereafter the processor provides a corresponding visual output on the display panel according to the type of the touch event. Although the touch sensitive surface and the display panel are implemented in this embodiment as two separate components to perform the input and output functions, the touch sensitive surface and the display panel can be integrated to perform the input and output functions in some embodiments.

The terminal device 700 can further include at least one sensor, e.g., an optical sensor, a motion sensor and other sensors. Particularly the optical sensor can include an ambient optical sensor and a proximity sensor, wherein the ambient optical sensor can adjust the brightness of the display panel according to the luminosity of ambient light rays, and the proximity sensor can turn off the display panel and/or a backlight when the terminal device 700 moves in proximity to an ear. A gravity acceleration sensor which is a motion sensor can detect the magnitudes of accelerations in respective directions (typically three axes) and can detect the magnitude and the direction of gravity when the sensor is stationary and can be configured to perform applications of identifying the posture of a terminal device (e.g., switching between landscape and portrait modes, relevant games, calibration of the posture of a magnetometer, etc.), a relevant function of identifying vibration (e.g., a pedometer, a knock, etc.), etc.; and the terminal device 700 can be further configured with a gyroscope, a barometer, a hygrometer, a thermometer, an infrared sensor and other sensors, and a repeated description of these components will be omitted here.

The audio circuit, a speaker and a microphone can provide an audio interface between the user and the terminal device 700. The audio circuit can convert received audio data into an electric signal and transmit the electric signal to the speaker, which is converted by the speaker into an audio signal for output; and on the other hand, the microphone converts a collected audio signal into an electric signal which is received by the audio circuit and then converted into audio data, and the audio data is further output to the processor for processing and then transmitted to another apparatus through the radio frequency circuit, or the audio data is output to the memory for further processing. The audio circuit may further include an earphone jack for communication between a peripheral earphone and the terminal device 700.

The WiFi is a technology of short-range wireless transmission, and the terminal device 700 can assist the user in receiving and transmitting an e-mail, browsing a webpage, accessing streaming media, etc., through the WiFi module, and the user is provided with a wireless access to the broadband Internet by the WiFi module. Although the WiFi module is illustrated in this embodiment, it can be appreciated that the WiFi module may not be necessarily required for the terminal device 700 but can be omitted as desired without departing from the scope of the disclosure.

The processor is a control component of the terminal device 700, has the respective components of the terminal device connected by various interfaces and lines, and runs or executes the software programs and/or modules stored in the memory and invokes the data stored in the memory to perform the various functions of the terminal device 700 and process the data to thereby manage and control the terminal device as a whole. Optionally the processor can include one or more processing cores; and optionally the processor can be integrated with an application processor and a modem processor, wherein the application processor generally handles the operating system, the user interfaces, the applications, etc., and the modem processor generally handles wireless communication. As can be appreciated, the modem processor above may not be integrated into the processor.

The terminal device 700 further includes a power source (e.g., a battery) powering the respective components, and optionally the power source can be logically connected with the processor through a power management system to thereby perform charging and discharging management, power consumption management, etc., through the power management system. The power source can further include one or more DC or AC power sources, recharging systems, power source failure detection circuits, power source transformers or inverters, power source status indicators and any other components.

Although not illustrated, the terminal device 700 can further include a camera, a Bluetooth module, etc., and a repeated description thereof will be omitted here. In an embodiment, the display component of the terminal device 700 is a touch screen display, and the terminal device 700 further includes a memory in which one or more programs are stored, wherein the one or more programs are configured to be executed by one or more processors. The one or more programs include instructions for performing the operations of:

Receiving a security grade authorization request transmitted from a display device and determining a security grade authorization threshold according to the display device; and

Determining multimedia resources to be played and transmitting play information corresponding to the multimedia resources to be played to the display device according to the security grade authorization threshold.

Optionally, determining the security grade authorization threshold according to the display device includes:

Reading the preset security grade authorization threshold corresponding to the display device; or

Displaying, by the terminal device, a setting message of the security grade authorization threshold and determining the security grade authorization threshold in response to a received user instruction.

Optionally, transmitting the play information corresponding to the multimedia resources to be played to the display device according to the security grade authorization threshold includes:

Determining security grades of the multimedia resources to be played;

Judging whether the security grades of the multimedia resources to be played satisfy a play condition specified by the security grade authorization threshold; and

If so, then transmitting the play information corresponding to the multimedia resources to be played to the display device;

Otherwise, displaying an alarm message, and transmitting the play information corresponding to the multimedia resources to be played to the display device after the alarm message is cleared.

Optionally, transmitting the play information corresponding to the multimedia resources to be played to the display device according to the security grade authorization threshold includes:

Determining security grades of the multimedia resources to be played;

Judging whether the security grades of the multimedia resources to be played satisfy a play condition specified by the security grade authorization threshold; and

If so, then transmitting the play information corresponding to the multimedia resources to be played directly to the display device.

In another embodiment, the display component of the terminal device 700 is a touch screen display, and the terminal device 700 further includes a memory in which one or more programs are stored, wherein the one or more programs are configured to be executed by one or more processors. The one or more programs include instructions for performing the operations of:

Receiving a security grade authorization request transmitted from a display device, determining a security grade authorization threshold according to the display device, and transmitting the security grade authorization threshold to the display device; and

Determining multimedia resources to be played among multimedia resources to be shared according to the security grade authorization threshold.

Optionally, determining the security grade authorization threshold according to the display device includes:

Reading, by the terminal device, the preset security grade authorization threshold corresponding to the display device; or

Displaying, by the terminal device, a setting message of the security grade authorization threshold and determining the security grade authorization threshold in response to a received user instruction.

Optionally, determining the multimedia resources to be played among the multimedia resources to be shared according to the security grade authorization threshold includes:

Receiving, by the terminal device, a browse request message transmitted from the display device based upon the security grade authorization threshold; and

Selecting, among the multimedia resources to be shared, multimedia resources, with mask level satisfying a play condition specified by the security grade authorization threshold, as the multimedia resources to be played according to security grades of the multimedia resources to be shared.

An embodiment of the disclosure further provides a display device, and FIG. 8 illustrates a display device, wherein the display device 800 can include a memory, an input unit, an output unit, and one or more processors and other components. Those skilled in the art can appreciate that the display device will not be limited to the structure of the display device 800 illustrated in FIG. 8 but can include more or fewer components than those illustrated in the figure or have some of the components combined or have different components arranged, wherein:

The memory can be configured to store software programs and modules, and the processor is configured to run the software programs and modules stored in the memory to thereby perform various function applications and data processing. The memory can include a high-speed random access memory and can further include a nonvolatile memory, e.g., at least one magnetic-disk memory device, a flash memory device or another volatile solid-state memory device. Correspondingly the memory can further include a memory controller configured to provide an access of the processor and the input unit to the memory.

The processor is a control center of the display device, has the respective components of the entire display device connected by various interfaces and lines, and runs or executes the software programs and/or modules stored in the memory and invokes the data stored in the memory to perform the various functions of the display device 800 and process the data to thereby manage and control the display device as a whole. Optionally the processor can include one or more processing cores; and optionally the processor can be integrated with an application processor and a modem processor, wherein the application processor generally handles the operating system, the user interfaces, the applications, etc., and the modem processor generally handles wireless communication. As can be appreciated, the modem processor above may not be integrated into the processor.

The display device can include input units, such as a television broadcast receiver, a High Definition Multimedia Interface (HDMI), a Universal Serial Bus (USB) interface, an audio and/or video input structure, etc. The input unit can further include a remote control signal receiver which is configured to receive the signal transmitted from the remote controller. Further, the input unit can include a touch sensitive surface and another input device, wherein the touch sensitive surface can be implemented in various types of resistive, capacitive, infrared, surface sound wave and other types. Another input device can include but will not be limited to one or more of a physical keyboard, functional keys (e.g., volume control press keys, a power-on or-off press key, etc.), a track ball, a mouse, a joystick, etc.

The output unit is configured to output an audio signal, a video signal, an alarm signal, a vibration signal, etc. The output unit can include a display panel, and an audio output module, etc. The display panel can be configured to display information input by the user or information provided to the user and various graphic user interfaces of the display device 800, wherein these graphic user interfaces can be composed of graphics, texts, icons, videos and any combination thereof. For example, the display panel can be configured in the form of a Liquid Crystal Display (LCD), an Organic Light-Emitting Diode (OLED) display, a flexible display, a 3D display, Cathode Ray Tube (CRT) display, Plasma Display Panel, etc.

The display device 800 can further include at least one sensor, e.g., an optical sensor, a motion sensor and other sensors. Particularly the optical sensor can include an ambient optical sensor and a proximity sensor, wherein the ambient optical sensor can adjust the brightness of the display panel according to the luminosity of ambient light rays, and the proximity sensor can turn off the display panel and/or a backlight when the display device 800 moves to some location. The display device 800 can be further configured with a gyroscope, a barometer, a hygrometer, a thermometer, an infrared sensor and other sensors.

The display device can further include an audio circuit (not shown in the FIG. 8). A speaker and a microphone can provide an audio interface between the user and the display device 800. The audio circuit can convert received audio data into an electric signal and transmit the electric signal to the speaker, which is converted by the speaker into an audio signal for output; and on the other hand, the microphone converts a collected audio signal into an electric signal which is received by the audio circuit and then converted into audio data, and the audio data is further output to the processor for processing and then transmitted to another display device, or the audio data is output to the memory for further processing. The audio circuit may further include an earphone jack for communication between a peripheral earphone and the display device.

Moreover the display device 800 can further include a Radio Frequency (RF) circuit. The RF circuit can be configured to receive and transmit a signal. Typically the RF circuit includes but will not be limited to an antenna, at least one amplifier, a tuner, one or more oscillators, a Subscriber Identifier Module (SIM) card, a transceiver, a coupler, a Low Noise Amplifier (LNA), a duplexer, etc. The display can further include a camera and a Bluetooth module, etc.

Moreover the display device 800 can further a WiFi (Wireless Fidelity) module (not shown in the figure). The WiFi is a technology of short-range wireless transmission, and the display device 800 can assist the user in receiving and transmitting an e-mail, browsing a webpage, accessing streaming media, etc., through the WiFi module, and the user is provided with a wireless access to the broadband Internet by the WiFi module. Although FIG. 8 illustrates the WiFi module, it can be appreciated that the WiFi module may not be necessarily required for the display device 800 but can be omitted as desired without departing from the scope of the disclosure.

In some embodiments, the display device 800 further includes one or more programs stored in a memory, and the one or more programs are configured to be executed by one or more processor. The one or more programs include instructions for performing the operations of:

Transmitting a security grade authorization request to a terminal device so that the terminal device determines a security grade authorization threshold according to the display device; and

Receiving play information, corresponding to multimedia resources to be played, transmitted from the terminal device according to the security grade authorization threshold.

Optionally receiving the play information, corresponding to the multimedia resources to be played, transmitted from the terminal device according to the security grade authorization threshold includes:

Receiving the play information, corresponding to the multimedia resources to be played satisfying the play condition specified by the security grade authorization threshold, transmitted from the terminal device is received; or

Receiving the play information, corresponding to the multimedia resources to be played failing to satisfy the play condition specified by the security grade authorization threshold, transmitted from the terminal device after an alarm message is cleared by the terminal device.

Moreover the one or more programs in the display device 800 can further include instructions for corresponding operations related to the operations above, e.g., the related operations mentioned in the embodiment above.

In some other embodiments, the display device 800 further includes one or more programs stored in a memory, and the one or more programs are configured to be executed by one or more processor. The one or more programs include instructions for performing the operations of:

Transmitting a security grade authorization request to a terminal device so that the terminal device transmits a security grade authorization threshold to the display device upon reception of the security grade authorization request; and

Determining multimedia resources to be played among multimedia resources to be shared stored in the terminal device according to the security grade authorization threshold.

Optionally determining the multimedia resources to be played among the multimedia resources to be shared stored in the terminal device according to the security grade authorization threshold includes:

Transmitting a browse request message carrying the security grade authorization threshold to the terminal device so that the terminal device selects, among multimedia resources to be shared stored in the terminal device, the multimedia resources with security grades satisfying a play condition specified by the security grade authorization threshold, as the multimedia resources to be played according to security grades of the multimedia resources to be shared.

Moreover the one or more programs in the display device 800 can further include instructions for corresponding operations related to the operations above, e.g., the related operations mentioned in the embodiment above.

In another aspect, still another embodiment of the disclosure further provides a computer readable storage medium which can be a computer readable storage medium included in the memories in the embodiments above; or can be a separately existing computer readable storage medium which is not installed into the terminal. The computer readable storage medium stores therein one or more programs (in some embodiments, the computer readable storage medium can be one or more magnetic-disk storage devices, flash memory devices or other nonvolatile solid-state storage devices, CD-ROMs, optical memories, etc.), and the one or more programs can be executed by one or more processors to perform the multi-screen interaction method of a multimedia resource above. For steps included in the method, reference can be made to the relevant description of the embodiments illustrated in FIG. 1 to FIG. 6, and a repeated description thereof will be omitted here.

The disclosure has been described in a flow chart and/or a block diagram of the method, the device (system) and the computer program product according to the embodiments of the disclosure. It shall be appreciated that respective flows and/or blocks in the flow chart and/or the block diagram and combinations of the flows and/or the blocks in the flow chart and/or the block diagram can be embodied in computer program instructions. These computer program instructions can be loaded onto a general-purpose computer, a specific-purpose computer, an embedded processor or a processor of another programmable data processing device to produce a machine so that the instructions executed on the computer or the processor of the other programmable data processing device create means for performing the functions specified in the flow(s) of the flow chart and/or the block(s) of the block diagram.

These computer program instructions can also be stored into a computer readable memory capable of directing the computer or the other programmable data processing device to operate in a specific manner so that the instructions stored in the computer readable memory create an article of manufacture including instruction means which perform the functions specified in the flow(s) of the flow chart and/or the block(s) of the block diagram.

These computer program instructions can also be loaded onto the computer or the other programmable data processing device so that a series of operational steps are performed on the computer or the other programmable data processing device to create a computer implemented process so that the instructions executed on the computer or the other programmable device provide steps for performing the functions specified in the flow(s) of the flow chart and/or the block(s) of the block diagram.

Although the preferred embodiments of the disclosure have been described, those skilled in the art benefiting from the underlying inventive concept can make additional modifications and variations to these embodiments. Therefore the appended claims are intended to be construed as encompassing the preferred embodiments and all the modifications and variations coming into the scope of the disclosure.

Evidently those skilled in the art can make various modifications and variations to the disclosure without departing from the spirit and scope of the disclosure. Thus the disclosure is also intended to encompass these modifications and variations thereto so long as the modifications and variations come into the scope of the claims appended to the disclosure and their equivalents.

1. A multi-screen interaction method of a multimedia resource, the method comprising:
receiving, by a terminal device, a security grade authorization request transmitted from a display device and determining a security grade authorization threshold according to the display device; and
determining, by the terminal device, multimedia resources to be played and transmitting play information corresponding to the multimedia resources to be played to the display device according to the security grade authorization threshold.

2. The method according to claim 1, wherein determining the security grade authorization threshold according to the display device comprises:
reading, by the terminal device, the preset security grade authorization threshold corresponding to the display device; or
displaying, by the terminal device, a setting message of the security grade authorization threshold and determining the security grade authorization threshold in response to a received user instruction.

3. The method according to claim 1, wherein transmitting the play information corresponding to the multimedia resources to be played to the display device according to the security grade authorization threshold comprises:
determining security grades of the multimedia resources to be played;
judging whether the security grades of the multimedia resources to be played satisfy a play condition specified by the security grade authorization threshold; and
if so, then transmitting the play information corresponding to the multimedia resources to be played to the display device;
otherwise, displaying an alarm message, and transmitting the play information corresponding to the multimedia resources to be played to the display device after the alarm message is cleared.

4. The method according to claim 1, wherein transmitting the play information corresponding to the multimedia resources to be played to the display device according to the security grade authorization threshold comprises:
determining security grades of the multimedia resources to be played;
judging whether the security grades of the multimedia resources to be played satisfy a play condition specified by the security grade authorization threshold; and
if so, then transmitting the play information corresponding to the multimedia resources to be played directly to the display device.

5. The method according to claim 1, wherein after the determining the security grade authorization threshold according to the display device, the method further comprises:
transmitting the security grade authorization threshold to the display device.

6. A multi-screen interaction method of a multimedia resource, the method comprising:
receiving, by a terminal device, a security grade authorization request transmitted from a display device, determining a security grade authorization threshold according to the display device, and transmitting the security grade authorization threshold to the display device; and
determining multimedia resources to be played among multimedia resources to be shared according to the security grade authorization threshold.

7. The method according to claim 6, wherein determining the security grade authorization threshold according to the display device comprises:
reading, by the terminal device, the preset security grade authorization threshold corresponding to the display device; or
displaying, by the terminal device, a setting message of the security grade authorization threshold and determining the security grade authorization threshold in response to a received user instruction.

8. The method according to claim 7, wherein determining the multimedia resources to be played among the multimedia resources to be shared according to the security grade authorization threshold comprises:
receiving, by the terminal device, a browse request message transmitted from the display device based upon the security grade authorization threshold; and
selecting, among multimedia resources to be shared, the multimedia resources with security grades satisfying a play condition specified by the security grade authorization threshold as the multimedia resources to be played according to security grades of the multimedia resources to be shared.

9. A terminal device, comprising:
a memory; and
one or more processors,
wherein the memory has computer readable program codes stored therein, and the one or more processors are configured to execute the computer readable program codes to perform:
receiving, by the terminal device, a security grade authorization request transmitted from a display device and determining a security grade authorization threshold according to the display device; and
determining, by the terminal device, multimedia resources to be played and transmitting play information corresponding to the multimedia resources to be played to the display device according to the security grade authorization threshold.

10. The terminal device according to claim 9, wherein determining the security grade authorization threshold according to the display device comprises:
reading, by the terminal device, the preset security grade authorization threshold corresponding to the display device; or
displaying, by the terminal device, a setting message of the security grade authorization threshold and determining the security grade authorization threshold in response to a received user instruction.

11. The terminal device according to claim 9, wherein transmitting the play information corresponding to the multimedia resources to be played to the display device according to the security grade authorization threshold comprises:
determining security grades of the multimedia resources to be played;
judging whether the security grades of the multimedia resources to be played satisfy a play condition specified by the security grade authorization threshold; and
if so, then transmitting the play information corresponding to the multimedia resources to be played to the display device;
otherwise, displaying an alarm message, and transmitting the play information corresponding to the multimedia resources to be played to the display device after the alarm message is cleared.

12. The terminal device according to claim 9, wherein transmitting the play information corresponding to the multimedia resources to be played to the display device according to the security grade authorization threshold comprises:
determining security grades of the multimedia resources to be played;
judging whether the security grades of the multimedia resources to be played satisfy a play condition specified by the security grade authorization threshold; and
if so, then transmitting the play information corresponding to the multimedia resources to be played directly to the display device.

13. A terminal device, comprising:
a memory; and
one or more processors,
wherein the memory has computer readable program codes stored therein, and the one or more processors are configured to execute the computer readable program codes to perform:
receiving, by a terminal device, a security grade authorization request transmitted from a display device, determining a security grade authorization threshold according to the display device, and transmitting the security grade authorization threshold to the display device; and
determining, by the terminal device, multimedia resources to be played among multimedia resources to be shared according to the security grade authorization threshold.

14. The terminal device according to claim 13, wherein determining the security grade authorization threshold according to the display device comprises:
reading, by the terminal device, the preset security grade authorization threshold corresponding to the display device; or
displaying, by the terminal device, a setting message of the security grade authorization threshold and determining the security grade authorization threshold in response to a received user instruction.

15. The terminal device according to claim 13, wherein determining the multimedia resources to be played among the multimedia resources to be shared according to the security grade authorization threshold comprises:
receiving, by the terminal device, a browse request message transmitted from the display device based upon the security grade authorization threshold; and
selecting, among multimedia resource to be shared, the multimedia resources with security grades satisfying a play condition specified by the security grade authorization threshold as the multimedia resources to be played according to security grades of the multimedia resources to be shared.
